(19) United States
(12) Patent Application Publication
(10) Pub. No.: US 2006/0223539 A1
(43) Pub. Date: Oct. 5, 2006

(54) Radio access architecture with resource coordination of a plurality of base stations owned by different entities

(76) Inventors: Holger Claussen, Swindon (GB); Francis Joseph Mullany, Blackrock (IE); Lester Tse Wee Ho, Swindon (GB); Louis Gwyn Samuel, Sindon (GB); Thierry E. Klein, Fanwood, NJ (US); George E. Rittenhouse, Holmdel, NJ (US)

Correspondence Address: WILLIAMS, MORGAN & AMERSON, 10333 RICHMOND, SUITE 1100, HOUSTON, TX, 77042, US

(21) Appl. No.: 11/095,023

(22) Filed: Mar. 31, 2005

(51) Int. Cl. H04Q 7/20

(52) U.S. Cl. 455/438

(57) ABSTRACT

In one aspect of the instant invention, a method is provided for controlling a communications system in which base stations owned by different entities are permitted to bid in an auction to establish a communications session for a mobile device. The method comprises sending a request to a first and second base station to bid on communicating with a mobile device. A bid is received from at least one of the first and second base stations for communicating with the mobile device. One of the first and second base stations is selected to communicate with the mobile device based on the received bid.

### BACKGROUND OF THE INVENTION

1. Field of the Invention

This invention relates generally to telecommunications, and, more particularly, to wireless communications.

2. Description of the Related Art

In the field of wireless telecommunications, such as cellular telephony, a system 100, such as that shown in FIG. 1, typically includes a plurality of base stations 110 distributed within an area to be serviced by the system 100. Various users within the area, fixed or mobile, may then access the system 100 and, thus, other interconnected telecommunications systems 130, via one or more of the base stations 110. Typically, a mobile device 120 maintains communications with the system 100 as the mobile device 120 passes through an area by communicating with one and then another base station 110, as the user moves. The mobile device 120 may communicate with the closest base station 110, the base station 110 with the strongest signal, the base station 110 with a capacity sufficient to accept communications, etc.

Typically, there is close coordination between the base stations 110 and a radio network controller (RNC) 140, with the RNC 140 in the dominant role, controlling the configuration and operation of the base stations 110. For example, for the mobile device 120 to maintain simultaneous communications between two of the base stations 110 (as would normally occur during a soft handover), both base stations are typically controlled by a single one of the RNCs 140. More generally, the RNC 140 centrally controls the pool of radio resources provided by the base stations under its control. Thus, conventionally, both layers of the system, base stations 110 and RNCs 140, are owned by the same entity.

Therefore, it is difficult to sustain other business models with a “division of labor” between multiple business entities. For example, base stations 110 owned by entities different from that owning the RNC 140 have no means to act on behalf of those owning entities since the relationship is dominated by the RNC 140.

A number of other approaches are well-known. For example, the burden is shared by the mobile network operator leasing from other business entities just the base station sites and backhaul facilities. However, the network operator still retains complete control over the equipment at all levels and hence is still responsible for the planning, organization, configuration, and maintenance of the entire network.

Alternatively, in Wireless Local Area Network (WLAN) systems, there is no radio network controller and hence it is possible for access points, which operate somewhat like a base station) to be owned by different entities, providing network transport service to third party entities that retain the customer relationship. However, this approach has little or no coordination between access points beyond the crude collision avoidance mechanisms in the respective MACs (medium access control, low-level mechanisms not designed for resources management), resulting in inefficiencies in the management of the radio resources. These inefficiencies become very significant in cellular systems where the distances to the mobile devices are much greater and the mobile device mobility is much higher (up to that of high-speed vehicles).

Agent architectures with various inter-agent negotiation mechanisms have been proposed for resource management; however, none of the architectures address the need for base stations and radio network controllers to be owned by different entities.

The present invention is directed to overcoming, or at least reducing, the effects of one or more of the problems set forth above.

### SUMMARY OF THE INVENTION

In one aspect of the instant invention, a method is provided for controlling a communications system. The method comprises sending a request to a first and second base station to bid on communicating with a mobile device. A bid is received from at least one of the first and second base stations for communicating with the mobile device. One of the first and second base stations is selected to communicate with the mobile device based on the received bid.

In another aspect of the instant invention, a method is provided for controlling a communications system. The method comprises receiving a request at a first base station to bid on communicating with a mobile device. Thereafter, a bid is provided. Subsequently, one of two indications may be received. The first indication is that the first base station has been selected to communicate with the mobile device, and the second indication is that the first base station has not been selected to communicate with the mobile device based on the received bid.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of a typical communications system;

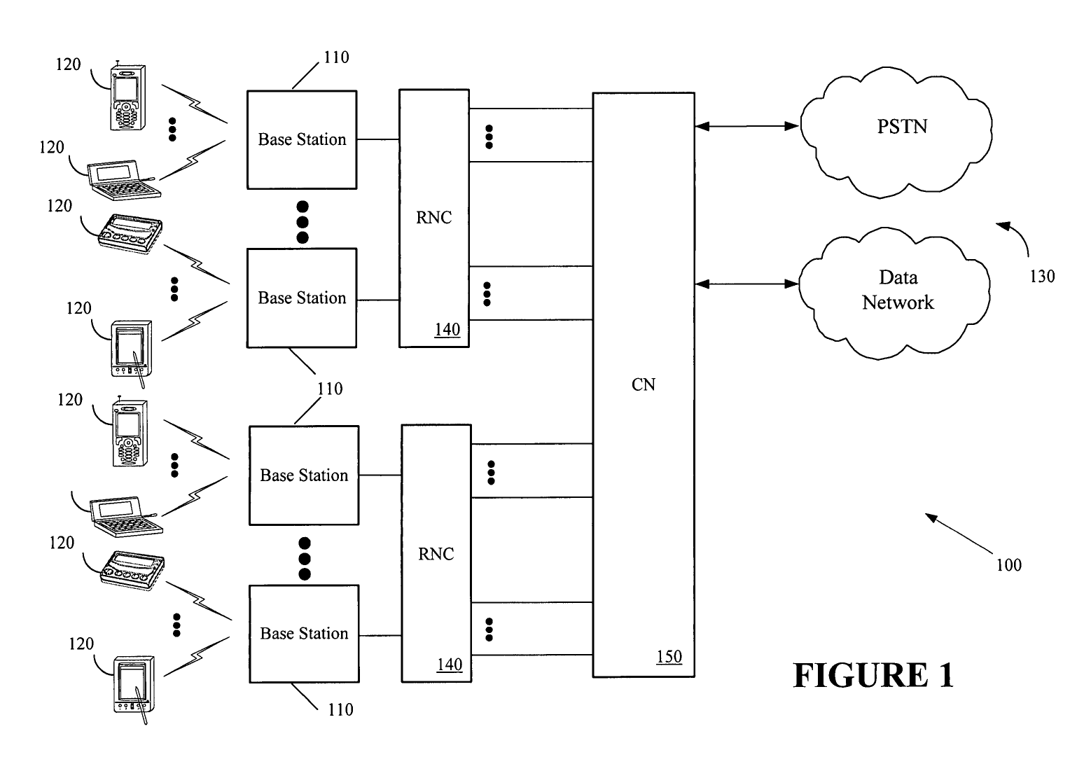

FIG. 2 is a block diagram of a communications system, in accordance with one embodiment of the present invention; and

FIG. 3 is a stylistic flowchart representation of a process performed by base stations and a radio network broker of FIG. 2.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

From the point-of-view of capital expenditure, the most expensive parts of a cellular system are the base stations 110 and the backhaul links or connections to the RNCs 140. It would be useful to have an architecture that allows a “division of labor,” whereby multiple business entities could be involved in supplying cellular coverage over a broad geographical area. For example, one entity could have base stations 110 covering one area, whilst a second entity has another set of base stations 110 dealing with a second (possibly overlapping) area. The end-customer relationship and service provision may be managed by a third party or alternatively, by one of the owners of the base stations. The issue then becomes how the overall system is integrated together to provide a consistent end-to-end service to the end user, particularly the network transport portions of the service.

In one embodiment of the instant invention, this “division of labor” may be accomplished by changing the relationship between the base stations and the radio network controllers. For example, it may be useful to replace the master/slave relationship between the RNCs and the base stations to one that is based on negotiation. Additionally, the RNCs no longer operate as controllers, but rather, more like brokers. This modified relationship can be managed on behalf of the network operator by means of agent software in the radio network “brokers.” Likewise, the base stations would include some form of agent software that acts on its behalf. Thus, the base station can now have interests that are not identical to the operator and thus can be owned by a separate entity.

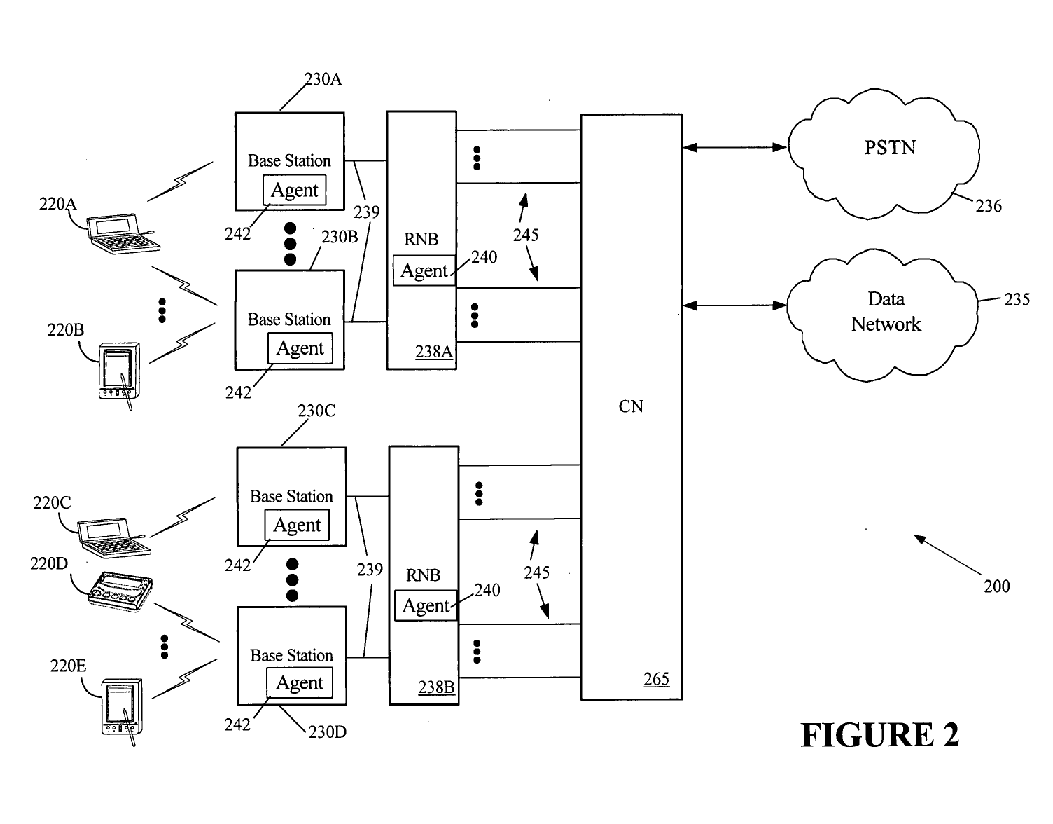

Turning now to the drawings, and specifically referring to FIG. 2, a communications system 200 is illustrated, in accordance with one embodiment of the present invention. For illustrative purposes, the communications system 200 of FIG. 2 is a Universal Mobile Telephone System (UMTS), although it should be understood that the present invention may be applicable to other systems that support data and/or voice communication. The communications system 200 allows one or more mobile devices 220 to communicate with a data network 235, such as the Internet, and/or a public telephone system (PSTN) 236 through one or more base stations 230. The mobile device 220 may take the form of any of a variety of devices, including cellular phones, personal digital assistants (PDAs), laptop computers, digital pagers, wireless cards, and any other device capable of accessing the data network 235 and/or the PSTN 236 through the base station 230.

In one embodiment, a plurality of the base stations 230 may be coupled to a Radio Network Broker (RNB) 238 by one or more connections 239, such as T1/EI lines or circuits, ATM circuits, cables, optical digital subscriber lines (DSLs), Ethernet/GigabitEthernet links, and the like. Although two RNBs 238A and 238B are illustrated, those skilled in the art will appreciate that more RNBs 238 may be utilized to interface with a large number of base stations 230. Generally, the RNB 238 operates in coordination with the base stations 230 to which it is connected with the aid of agent software 240 in the RNB 238 and agent software 242 in the base station 230. The RNB 238 of FIG. 2 generally provides replication, communications, runtime, and system management services, and, as discussed below in more detail below, may be involved in coordinating the transition of the mobile device 220 during transitions (e.g. soft handoffs) between the base stations 230.

The RNBs 238 are also coupled to a Core Network (CN) 265 via a connection 245, which may take on any of a variety of forms, such as T1/EI lines or circuits, ATM circuits, cables, optical digital subscriber lines (DSLs), Ethernet/GigabitEthernet links, and the like. Generally the CN 265 operates as an interface to the data network 235 and/or to the public telephone system (PSTN) 236. The CN 265 may perform a variety of functions and operations, such as user authentication, however, a detailed description of the structure and operation of the CN 265 is not necessary to an understanding and appreciation of the instant invention. Accordingly, to avoid unnecessarily obfuscating the instant invention, further details of the CN 265 are not presented herein.

Thus, those skilled in the art will appreciate that the communications system 200 enables the mobile devices 220 to communicate with the data network 225, the PSTN 260 and/or one another. It should be understood, however, that the configuration of the communications system 200 of FIG. 2 is exemplary in nature, and that fewer or additional components may be employed in other embodiments of the communications system 200 without departing from the spirit and scope of the instant invention.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

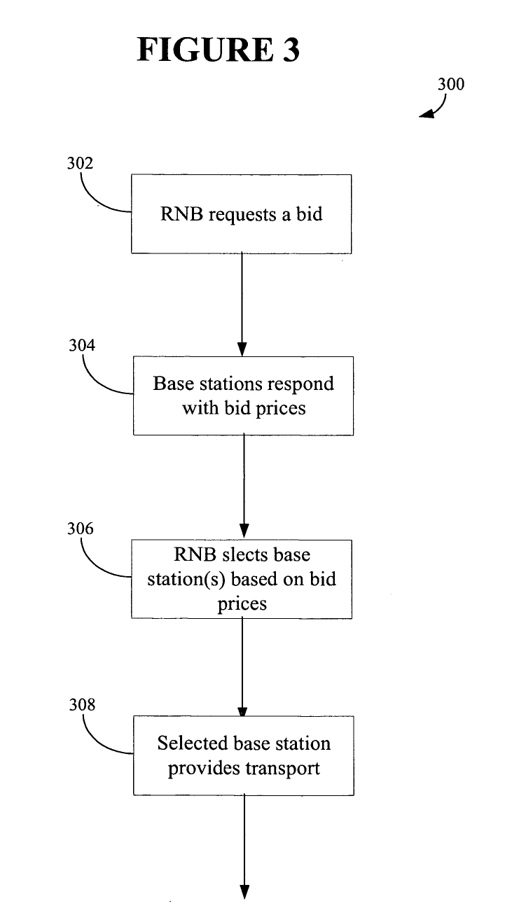

The interoperation of the agent software 240, 242 within the RNBs 238 and the base stations 110, respectively, may be appreciated by reference to the flowchart of FIG. 3 in combination with the block diagram of FIG. 2. The structure and organization of the agent software 240, 242 may take on any of a variety of forms, and in one embodiment of the instant invention may take the form of an auction.

The process 300 begins at block 302 with the RNB 238 requesting a bid for a network transport for a particular mobile device 220. For example, in FIG. 2, the RNB 238A (owned by operator “A”) places a request for bids to base stations 230A and 230B (owned by providers “B” and “C”), for providing network transport to 220A, which is illustrated as communicating with both of the base station 230A and 230B. At block 304, the base stations 230A and 230B respond with bid prices, based, at least in part, on the information they have about the cost of supporting the transport requirements of the mobile device 220A. At block 306, the RNB 238A selects the base station with the most competitive bid. Assuming that the base station 230B has provided the most competitive bid, the RNB 238A delivers a signal to at least the selected base station 230B, indicating that the base station 230B is to provide the transport. In some embodiments of the instant invention, it may be useful to communicate the identity of the selected bidder to the losing base stations as well, or alternatively, to provide an indication to the losing base station 230A that it was not selected. In this manner, any associated reserved resources (if any) of the losing base station 230A will be freed for other uses. Those skilled in the art will appreciate that the agent software 242 of the base station 230A may also be configured to “time out” after a preselected period of time so that its resources are automatically freed. At block 308, the selected base station 230B then provides the transport at the bid price.

Those skilled in the art will appreciate that the structure and organization of the agent software 240, 242 may take forms other than that of an auction without departing from the spirit and scope of the instant invention. Generally, the process involves analyzing some form of a market, or negotiating within that market, for access to the base stations 230, with the outcome of the analysis/negotiation being the formation of a contract between the RNB 238 and one of the base stations 230.

Fast and/or soft handovers can be accommodated by the RNB 238 accepting two or more base stations 230. In one embodiment of the instant invention, the RNB 238 may select the base stations 230 with the lowest bids; however, those skilled in the art will appreciate that a variety of other factors may be used in determining which bids to accept. After two of the base stations 230 are accepted by the RNB 238, then the fast and/or soft handover may be implemented using well known techniques, as defined in existing standards. However, the method for determining the pricing may be modified since the resource usage depends on the number of base stations 230 involved in the delivery. Two exemplary mechanisms for determining pricing are described herein.

An initial round of bidding may be used to identify a subset of the base stations 230 that are able to support a given mobile device 220. In one embodiment of the instant invention, it may be useful to identify those base stations that are able to support the mobile device 220 at the lowest cost. Thereafter, a second round of negotiations between the RNB 238 and the selected subset of base stations 230 may be used to settle the price.

For fast handover situations, a method involving resource reservations that relies on a probability of resource usage may be used. The method is described in co-pending application Ser. No. 10/609,746 entitled “A Method of Transport Provision for a Service to a User,” which is subject to an assignment to a common assignee. The entire content of the co-pending application is herein incorporated by reference in its entirety. Given that pricing will, to at least some extent, be related to the resource reservation for a given mobile device 220, this technique could be used by the RNB 238 to adjust the pricing with or without reliance on bids from the base stations 110 and/or 230. This technique requires the RNB 238 to be able to predict a priori the impact of soft handover/fast handover, at least in the average. In some embodiments of the instant invention, accurate prediction may be useful, but is not a requirement for application of the technique.

Where handover can occur slowly, the base station 230 could trade contracts between themselves or enter renegotiation with the RNB 238.

The negotiation between the RNB 238 and the base stations 230 need not take place on a per-call or per-session basis. Both faster and slower time-scales are feasible. For example, the RNB 238 may negotiate for an aggregate set of resources, i.e., enough radio resource to support multiple calls. Such a scheme may be useful in geographic areas where there is little competition between different base station providers and has the advantage of reducing the frequency of interaction between the various entities.

The RNB 238 can also be applied to networks other than cellular and also to networks without the equivalent of an RNC (e.g., WLAN 802.11). This enables one business entity to easily offer heterogeneous network technologies via third party suppliers, without these suppliers of network transport having centralized resource management of even their own base stations/access points.

By implementing the instant invention, a communications system may be constructed in which the base stations 230 and the RNB 238 no longer have to be owned by the same business entity. Further, different base stations 230 can be owned by different business entities, reducing the burden on any one entity to provide a complete end-to-end service, with complete geographical coverage, and yet, network resources can still be allocated in an optimal manner.

From a societal perspective, the invention removes the need for each operator to supply complete coverage at great cost and hence the overall market may act in a more economically efficient manner.

Generally, auctions are an efficient method for the allocation of distributed resources, particularly where some of the supplying nodes are owned by different business entities, as discussed above. However, if some of the suppliers are owned by the same entity or are formally collaborating with each other, auction structure may prove problematic in that supposedly collaborating nodes may inadvertently compete with each other. This forces them to interact directly with each other before and during the bidding process. If these nodes are widely separated, such frequent, direct communications may prove expensive to support. Thus, in some embodiments of the instant invention it may be useful to provide an auction structure in which these communications are reduced.

There are at least four common auction variations that could be employed in one or more embodiments of the instant invention. For example, open auctions, such as English and Dutch auctions could be implemented. Open auctions typically allow for multiple bidding rounds and all participating bidders (in this case suppliers of the resource) can see all communications. In the distributed resource markets discussed herein, the open auction variation has certain drawbacks. For example, a relatively large amount of communications may be required to support an open auction. Further, significant competitive information may be revealed by the process.

Alternatively, several types of sealed-bid auctions may be employed. For example, first-price sealed-bid auctions could be employed in one embodiment of the instant invention. In this type of auction, each participant places one confidential bid with the broker/auctioneer and the broker accepts the supplier with the most desirable bid (lowest in this case) as the supply price given in that bid. Generally, losing bidders are informed only that they have lost the bid, and no other competitive information is exchanged.

A second-price sealed-bid auction (also known as a Vickrey auction) could also be used in one embodiment of the instant invention. In this type of auction, the broker again accepts the supplier with the lowest bid, but the price selected is that of the next lowest bid. Similarly, a kth-price sealed-bid auction could also be employed. This type of auction is similar to the Vickery auction, except that the broker sets the supply price to that of the kth-lowest bid.

While the sealed-bid auctions may be useful in certain applications, they all suffer a significant shortcoming in that they do not make any allowances for suppliers that may wish to collaborate or who may be owned by the same entity. In the absence of relatively frequent communications between the suppliers, they may end up competing with each other. Such a situation is, of course, a disincentive for multiple-bidder ownership and collaboration

Generally, the auction structure should also be such that there is little or no incentive for collaborating suppliers to directly (and privately) communicate with each other, since this communication results in a relatively non-transparent market for individual suppliers with no such relationship.

In some embodiments of the instant invention, it may be useful to employ a modified auction process. For example, upon determining the winning bid, the broker/auctioneer may inform those suppliers that collaborate with, or who are owned by the same entity as, the winning supplier of the fact that is was a collaborating supplier, or a supplier owned by the same entity, that won the bid. This information allows the losing suppliers to correctly adjust their bidding strategies (e.g., generally so as not to compete too aggressively). Other losing suppliers that belong to competing entities will, from the lack of such notification, know only that it was a competing supplier that won, and hence can again correctly adjust their bidding strategies (e.g., generally so as to compete more aggressively).

Alternatively or additionally, a modified version of the Vickrey auction may be used whereby the auction is won by the lowest bidding supplier, but the supply price used is that of the bid of the lowest competing supplier. If a non-competing supplier bid lower than the lowest competing supplier, its bid price, unlike in a standard Vickrey auction, will be ignored. This auction structure is unlike the general kth-price sealed-bid auction in that the ranking of the bid with the price awarded for the winning supplier, varies depending on the position of the lowest competing supplier.

In some applications of the instant invention, it may be useful to provide more information to the collaborating suppliers, or those who are owned by the same entity as the winning supplier. For example, it may be useful to provide information such as the identity of the winning supplier and/or the winning price.

Alternatively or additionally, a modified version of the first-price sealed-bid auction may be used. Here, the auction is again awarded to the lowest bidder, but the price finally awarded is that of the highest collaborating supplier (or supplier owned by the same entity) below the lowest competing supplier. This type of auction may be useful in that it has an advantage that it may be more easily accepted by the general public where there is little understanding of the benefits of pricing according to the competitor's bid. However it does unduly benefit very large pools of suppliers in that they have a better chance of coming in with a bid just below that of the lowest competing bid.

Those skilled in the art will appreciate that while the instant invention has been described in terms of suppliers bidding to supply a service to a buyer, it may find application in an environment where there are multiple buyers for an item and they bid with purchasing prices (high bid wins). The instant invention may find application where a number of buyers are collaborating, or who are owned by a single entity.

Similarly, those skilled in the art will appreciate that while the instant invention has been described in terms of suppliers bidding to supply a single item or service, it may find application in an environment where the suppliers are bidding to provide multiple items and/or services in a single auction.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by the control units cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

We claim:

1. A method for controlling a communications system, comprising:
sending a request to a first and second base station to bid on communicating with a mobile device;
receiving a bid from at least one of the first and second base stations for communicating with the mobile device; and
selecting one of the first and second base stations to communicate with the mobile device based on the received bid.

2. A method, as set forth in claim 1, further comprising:
indicating to the selected one of the first and second base stations that the selected base station is to communicate with the mobile device.

3. A method, as set forth in claim 1, further comprising:
indicating to the non-selected one of the first and second base stations that the selected base station is to communicate with the mobile device.

4. A method, as set forth in claim 3, wherein indicating to the non-selected one of the first and second base stations that the selected base station is to communicate with the mobile device further comprises determining that the first and second base stations are collaborating base stations and indicating to the non-selected on of the first and second base stations that the selected base station is a collaborating base station.

5. A method, as set forth in claim 1, further comprising:
indicating to the non-selected one of the first and second base stations that the non-selected base station has not been selected to communicate with the mobile device.

6. A method, as set forth in claim 1, wherein receiving the bid from at least one of the first and second base stations for communicating with the mobile device further comprises receiving a bid from both of the first and second base stations for communicating with the mobile device and wherein selecting one of the first and second base stations to communicate with the mobile device based on the received bid further comprises selecting the first base stations to communicate with the mobile device in response to the bid received from the first base station being more competitive than the bid received from the second base station.

7. A method, as set forth in claim 5, wherein selecting the first base stations to communicate with the mobile device in response to the bid received from the first base station being more competitive than the bid received from the second base station further comprises selecting the first base stations to communicate with the mobile device in response to the bid received from the first base station being lower cost than the bid received from the second base station.

8. A method, as set forth in claim 1, wherein selecting one of the first and second base stations to communicate with the mobile device based on the received bid further comprises selecting one of the first and second base stations to communicate with at least one mobile device for a plurality of communications sessions based on the received bid.

9. A method, as set forth in claim 1, wherein selecting one of the first and second base stations to communicate with the mobile device based on the received bid further comprises selecting one of the first and second base stations to communicate with the mobile device for a single communications session based on the received bid.

10. A method for controlling a communications system, comprising:
receiving a request at a first base station to bid on communicating with a mobile device;
providing the bid; and
receiving one of an indication that the first base station has been selected to communicate with the mobile device and not selected to communicate with the mobile device based on the received bid.

11. A method, as set forth in claim 10, further comprising facilitating a communication session with the mobile device in response to receiving the indication that the first base station has been selected to communicate with the mobile device based on the received bid.

12. A method, as set forth in claim 10, further comprising releasing resources reserved for communicating with the mobile device in response to receiving the indication that the first base station has not been selected to communicate with the mobile device based on the received bid.

13. A method, as set forth in claim 10, further comprising receiving an indication that a collaborating base station has been selected to communicate with the mobile device.

14. A method, as set forth in claim 13, further comprising adjusting future bids based on receiving the indication that the collaborating base station has been selected to communicate with the mobile device.

15. A method, as set forth in claim 14, wherein adjusting future bids based on receiving the indication that the collaborating base station has been selected to communicate with the mobile device further comprises making future bids less aggressive in response to receiving the indication that the collaborating base station has been selected to communicate with the mobile device.

16. A method, as set forth in claim 10, further comprising releasing resources reserved for communicating with the mobile device after a preselected duration of time in response to not receiving the indication that the first base station has been selected to communicate with the mobile device.

17. A method, as set forth in claim 10, wherein receiving the indication that the first base station has been selected to communicate with the mobile device further comprises receiving an indication that the first base station has been selected to communicate with the mobile device for a single communications sessions.

18. A method, as set forth in claim 10, wherein receiving the indication that the first base station has been selected to communicate with the mobile device further comprises receiving an indication that the first base station has been selected to communicate with the mobile device for a plurality of communications sessions.
